(19) United States
(12) Patent Application Publication
(10) Pub. No.: US 2023/0230344 A1
(43) Pub. Date: Jul. 20, 2023

(54) SIGNAL COLOR DETERMINATION DEVICE AND SIGNAL COLOR DETERMINATION METHOD

(71) Applicant: DENSO TEN Limited, Kobe-shi (JP)

(72) Inventors: Yasutaka OKADA, Kobe-shi (JP); Ryusuke SEKI, Kobe-shi (JP); Yuki KATAYAMA, Kobe-shi (JP)

(73) Assignee: DENSO TEN Limited, Kobe-shi (JP)

(21) Appl. No.: 17/726,837

(22) Filed: Apr. 22, 2022

(30) Foreign Application Priority Data
Jan. 17, 2022 (JP) 2022-005078

(51) Int. Cl. G06V 10/56; G06V 10/22; G06V 20/60

(52) U.S. Cl. CPC G06V 10/56; G06V 10/22; G06V 20/60; G06V 20/584

(57) ABSTRACT

A signal color determination device includes a processor configured to acquire a captured image. If a part of a plurality of signal lamps of a traffic signal is detected from the captured image, the processor determines a signal color of the traffic signal.

### CROSS-REFERENCE TO RELATED APPLICATIONS

This nonprovisional application claims priority under 35 U.S.C. § 119(a) on Patent Application No. 2022-005078 filed in Japan on Jan. 17, 2022, the entire contents of which are hereby incorporated by reference.

### BACKGROUND OF THE INVENTION

### Field of the Invention

The present invention relates to a technique for determining a signal color of a traffic signal by using image data.

### Description of Related Art

For instance, JP-A-2019-121307 discloses that when a traffic signal shielded environment is determined in which a traffic signal cannot be recognized from an image taking unit, it is possible to increase possibility that the image taking unit can visually recognize the traffic signal by generating a new travel schedule.

### SUMMARY OF THE INVENTION

In the configuration in which the travel schedule is changed to enable to recognize the traffic signal, it is concerned that time necessary for recognizing the traffic signal may be increased. In some cases, there may occur a situation in which the traffic signal cannot be recognized, and it cannot be determined what color the signal color of the traffic signal is or was. It is convenient if the signal color of the traffic signal can be determined easily without change or the like of the travel schedule.

In view of the above points, it is an object of the present invention to provide a technique that can increase possibility that a signal color determination result can be obtained in the configuration of using image data for determining a signal color of a traffic signal.

An exemplary signal color determination device of the present invention includes a processor that obtains a captured image. When a part of a plurality of signal lamps of the traffic signal is detected from the captured image, the processor determines a signal color of the traffic signal.

### BRIEF DESCRIPTION OF THE DRAWINGS

FIG. 1 is a block diagram illustrating a schematic configuration of a signal color determination system.

FIG. 2 is a block diagram illustrating a functional configuration of a processing unit of a signal color determination device.

FIG. 3A is a diagram for describing a traffic signal.

FIG. 3B is a diagram for describing a traffic signal.

FIG. 4 is a flowchart illustrating an example of a flow of a signal color determination method using the signal color determination device.

FIG. 5 is a table illustrating results of color determination of a red color region, a yellow color region, and a blue color region, and a signal color determined on the basis of the results.

FIG. 6A is a table illustrating results of color determination of the yellow color region and the blue color region, and a signal color determined on the basis of the results.

FIG. 6B is a table illustrating results of color determination of the red color region and the yellow color region, and a signal color determined on the basis of the results.

FIG. 6C is a table illustrating results of color determination of the red color region and the blue color region, and a signal color determined on the basis of the results.

### DETAILED DESCRIPTION OF THE PREFERRED EMBODIMENTS

Hereinafter, an exemplary embodiment of the present invention is described in detail with reference to the drawings.

<1. Signal Color Determination System>

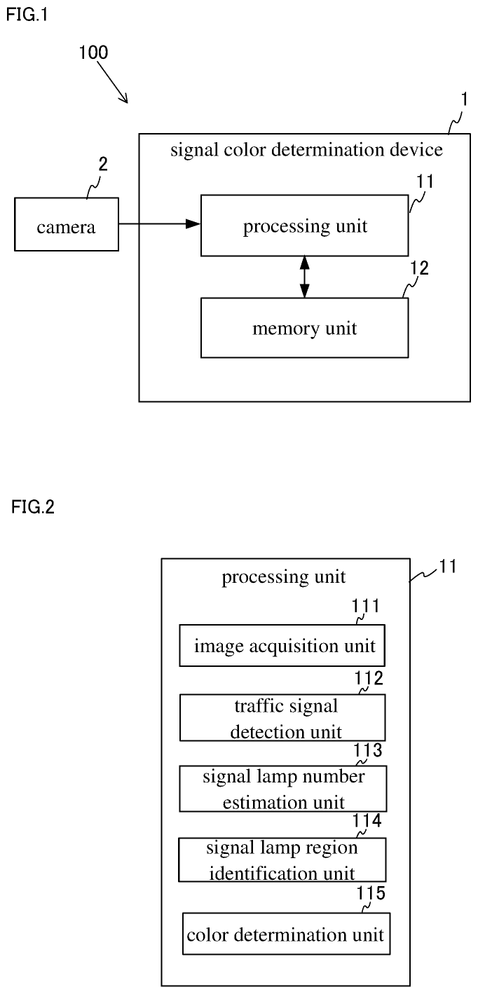

FIG. 1 is a block diagram illustrating a schematic structure of a signal color determination system 100 according to an embodiment of the present invention. The signal color determination system 100 is a system for determining a signal color of a traffic signal using image data. The signal color determination of a traffic signal means to determine a color of a lighted signal lamp among a plurality of signal lamps of the traffic signal. In this embodiment, the traffic signal is a traffic light signal. As illustrated in FIG. 1, the signal color determination system 100 includes a signal color determination device 1 and a camera 2.

The signal color determination device 1 determines a signal color of a traffic signal by using image data. The signal color determination device 1 may be mounted in a vehicle or in other place. The signal color determination device 1 that is mounted in a vehicle may be an in-vehicle device that is fixedly mounted in the vehicle or may be a portable device that can be taken out of the vehicle. The signal color determination device 1 may be included in a drive recorder that is installed in the vehicle, for example. Alternatively, the signal color determination device 1 may be included in a mobile terminal such as a smartphone or a tablet terminal. Alternatively, the signal color determination device 1 may be included in a server device or the like that can communicate with a device mounted in the vehicle using a communication network such as the Internet. The signal color determination device 1 may be included in a personal computer that cannot communicate with a device mounted in the vehicle.

The camera 2 includes an optical system and an image sensor such as a charge coupled device (CCD) sensor or a complementary metal oxide semiconductor (CMOS) sensor. The camera 2 is mounted in the vehicle and takes images around the vehicle. The camera 2 is for example a front camera that takes pictures in front of the vehicle. The front camera is disposed at a windshield or the like of the vehicle, for example. The camera 2 may be a monocular camera or a stereo camera, for example. The camera 2 may be an in-vehicle camera that is fixedly mounted in the vehicle or a mobile camera that can be taken out of the vehicle.

The camera 2 can communicate with the signal color determination device 1 using at least one of wired and wireless connection. The camera 2 outputs captured images (specifically, image data) to the signal color determination device 1. The camera 2 outputs the captured images to the signal color determination device 1 at a constant time interval, for example.

Note that in this embodiment, the camera 2 is a device separated from the signal color determination device 1. However, the camera 2 may be included in the signal color determination device 1. Further, the camera 2 may not be able to communicate with the signal color determination device 1. In this case, the signal color determination device 1 may obtain the image data taken by the camera 2 via a portable recording medium such as an SD card, for example.

<2. Signal Color Detection Device>

As illustrated in FIG. 1, the signal color determination device 1 includes a processing unit 11. The signal color determination device 1 further includes a memory unit 12. The signal color determination device 1 may be a so-called computer device.

The processing unit 11 includes a processor that performs arithmetic processing or the like. The processor may include a central processing unit (CPU), for example. In addition, the processor may include a CPU and a graphics processing unit (GPU), for example. The processing unit 11 may be constituted of a single processor or a plurality of processors. If it is constituted of a plurality of processors, the processors should be connected to each other in a communicable manner.

The memory unit 12 includes a volatile memory and a nonvolatile memory. The volatile memory may include a random access memory (RAM), for example. The nonvolatile memory may include a read only memory (ROM), a flash memory, and a hard disk drive, for example. The nonvolatile memory stores a computer readable program and data. The nonvolatile memory may appropriately store parameters for a learned model after machine learning is performed.

FIG. 2 is a block diagram illustrating a functional configuration of the processing unit 11 of the signal color determination device 1 according to the embodiment of the present invention. In this embodiment, functions of the processing unit 11 are realized by the processor executing arithmetic processing in accordance with the program stored in the memory unit 12. As illustrated in FIG. 2, the processing unit 11 includes, as its functions, an image acquisition unit 111, a traffic signal detection unit 112, a signal lamp number estimation unit 113, a signal lamp region identification unit 114, and a color determination unit 115.

Note that the scope of this embodiment may include a computer program that allows the processor (computer) to realize at least a part of functions of the signal color determination device 1. In addition, the scope of this embodiment may include a computer readable nonvolatile recording medium that stores such the computer program. The nonvolatile recording medium may include not only the nonvolatile memory described above but also an optical recording medium (such as an optical disc), a magneto-optic recording medium (such as a magneto-optic disk), a USB memory, an SD card, and the like, for example.

In addition, the individual units 111 to 115 described above may be realized by allowing the processor to execute the program, i.e., by software as described above, but they may be realized by other method. The individual units 111 to 115 described above may be realized by using an application specific integrated circuit (ASIC), a field programmable gate array (FPGA), or the like, for example. In other words, the individual units 111 to 115 described above may be realized by hardware using a dedicated IC or the like. Alternatively, the individual units 111 to 115 described above may be realized using both software and hardware. In addition, the individual units 111 to 115 described above are conceptual components. Functions performed by one component may be distributed into a plurality of components. Further, functions of a plurality of components may be integrated into one component.

The image acquisition unit 111 acquires a captured image (image data). In other words, the processing unit 11 acquires the captured image. The processing unit 11 acquires the captured image and processes the same. In this embodiment, the image acquisition unit 111 acquires the image from the camera 2. Note that the image acquisition unit 111 may acquire the captured image from the camera 2 via other device.

Alternatively, the image acquisition unit 111 may acquire the captured image taken by the camera 2 from a recording medium such as the memory unit 12.

The captured image acquired by the image acquisition unit 111 is the captured image taken by the camera 2 mounted in the vehicle. Specifically, the image acquisition unit 111 acquires the captured image around the vehicle. In this embodiment, the image acquisition unit 111 acquires the captured image of a view in front of the vehicle. Note that in the captured image, a traffic signal is visible in some cases and is not visible in other cases.

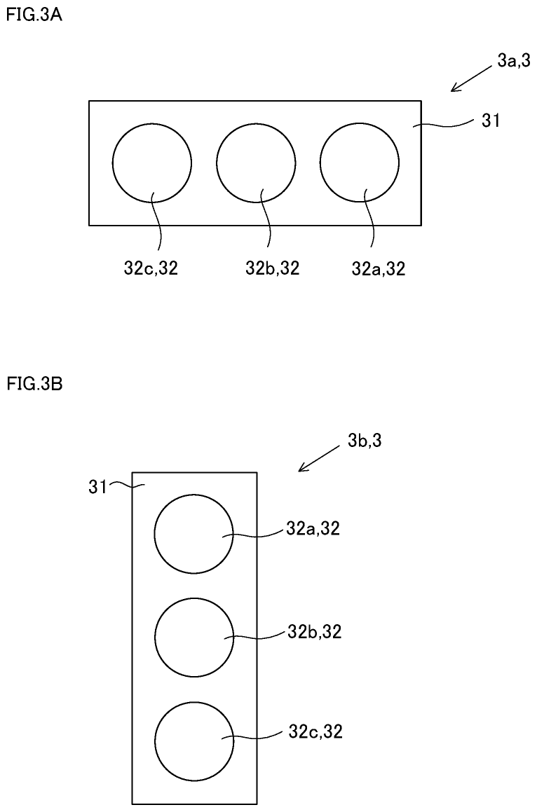

The traffic signal detection unit 112 detects a traffic signal from the captured image. FIGS. 3A and 3B are diagrams for describing traffic signals 3 detected by the traffic signal detection unit 112. As illustrated in FIGS. 3A and 3B, the traffic signal 3 detected by the traffic signal detection unit 112 includes a traffic signal main body 31 and a plurality of signal lamps 32 held by the traffic signal main body 31. Specifically, the plurality of signal lamps 32 are three signal lamps 32a, 32b and 32c. In other words, the traffic signal 3 is a three-lamp traffic signal.

Note that a traffic signal 3a illustrated in FIG. 3A is a horizontal traffic signal having the plurality of signal lamps 32 aligned horizontally. A traffic signal 3b illustrated in FIG. 3B is a vertical traffic signal having the plurality of signal lamps 32 aligned vertically. The traffic signals 3 in this embodiment include the horizontal traffic signal 3a and the vertical traffic signal 3b.

Three signal lamps 32a, 32b and 32c light in different colors. In other words, the traffic signal 3 is a three-color traffic signal. Note that in the traffic signal 3 of this embodiment, two or more of three signal lamps 32a, 32b and 32c do not light at the same time, but only one of them lights. For instance, if the first signal lamp 32a lights, the second signal lamp 32b and the third signal lamp 32c do not light.

The three lighting colors of the signal lamps 32a, 32b and 32c, and an arrangement order of the colors are prescribed in traffic laws of each country, for example. For instance, in the horizontal traffic signal 3a in Japan, a red color signal lamp 32a, a yellow color signal lamp 32b, and a blue color signal lamp 32c are arranged from right to left. Further, in the vertical traffic signal 3b in Japan, the red color signal lamp 32a, the yellow color signal lamp 32b, and the blue color signal lamp 32c are arranged from top to bottom. Note that the colors of the signal lamps of the traffic signal 3 and arrangement order thereof may be different depending on country. For instance, the blue color signal lamp 32c in Japan corresponds to a green color signal lamp in U.S.A. or other countries.

Specifically, the traffic signal detection unit 112 detects the three-lamp traffic signal 3 including three signal lamps 32a, 32b and 32c that light in different colors from the captured image. In other words, the processing unit 11 detects the three-lamp traffic signal 3 including three signal lamps 32a, 32b and 32c that light in different colors from the captured image.

For instance, the traffic signal detection unit 112 uses a learned object detection model after machine learning so as to detect the traffic signal from the captured image. The machine learning may be supervised learning that uses training data set with correct label. An object detection algorithm that is used in the object detection model may be a known algorithm such as R-CNN, Fast R-CNN, Faster R-CNN, YOLO, or SSD, for example. Note that other image recognition technique such as pattern matching may be used for detection of the traffic signal 3.

The signal lamp number estimation unit 113 estimates the number of the signal lamps 32 visible in a traffic signal region of the traffic signal 3 detected in the captured image. In other words, the processing unit 11 estimates the number of the signal lamps 32 visible in the captured image of the detected traffic signal 3. The learned model after machine learning may be used for estimating the number of the signal lamps 32. The machine learning may be configured for example to prepare a training data set with correct label including a pattern in which three signal lamps 32 are visible, a pattern in which two signal lamps 32 are visible, and a pattern in which one signal lamp 32 is visible, and to use the training data set for allowing a deep neural network to learn.

Note that in an image of the pattern in which three signal lamps 32 are visible, all the three signal lamps 32a, 32b and 32c of the traffic signal 3 are visible in the image without being hidden by an obstacle. The training data set with correct label includes this pattern of image.

In addition, in an image of the pattern in which two signal lamps 32 are visible, only one of the three signal lamps 32a, 32b and 32c of the traffic signal 3 is hidden by an obstacle, and two other signal lamps 32 are visible in the image. Specifically, there are three patterns in which two signal lamps 32 are visible. The three patterns include, for example, a pattern in which the red color signal lamp 32a is hidden while the yellow color signal lamp 32b and the blue color signal lamp 32c are visible in the image, a pattern in which the yellow color signal lamp 32b is hidden while the red color signal lamp 32a and the blue color signal lamp 32c are visible in the image, and a pattern in which the blue color signal lamp 32c is hidden while the red color signal lamp 32a and the yellow color signal lamp 32b are visible in the image. The training data set with correct label includes these three patterns of images.

In addition, in an image of the pattern in which one signal lamp 32 is visible, two of three signal lamps 32a, 32b and 32c of the traffic signal 3 are hidden by an obstacle, and one remaining signal lamp 32 is visible in the image. Specifically, there are three patterns that have one signal lamp 32. The three patterns include, for example, a pattern in which only the red color signal lamp 32a is visible in the image, a pattern in which only the yellow color signal lamp 32b is visible in the image, and a pattern in which only the blue color signal lamp 32c is visible in the image. The training data set with correct label includes these three patterns of images.

Note that the obstacle described above is for example a vehicle such as a truck in front of the camera 2, a tree near the traffic signal, or a part of the vehicle in which the camera 2 is mounted. In addition, the estimation of the number of the signal lamps 32 may be performed without using the learned model after machine learning. For instance, it may be possible to estimate a size of the traffic signal 3 visible in the captured image, and to estimate the number of the signal lamps 32 from the estimated size of the traffic signal 3.

The signal lamp region identification unit 114 identifies which color region the signal lamp 32 visible in the captured image exists in. In other words, the processing unit 11 identifies which color region the signal lamp 32 visible in the captured image exists in. As described above, the traffic signal 3 has a predetermined arrangement of the signal lamps 32 of individual colors. Therefore, it is possible to identify which color region the signal lamp 32 visible in the captured image exists in, on the basis of the captured image. In this embodiment, processes performed by the signal lamp region identification unit 114 include a process of extracting the color region identified in which the signal lamp 32 exists, as a preferred configuration.

Similarly to the case of estimation of the number of the signal lamps, for example, the functions of the signal lamp region identification unit 114 may be obtained by using the learned model (e.g. the deep neural network) after learning by using the training data set with correct label. With this configuration, the process of estimating the number of the signal lamps 32 and the process of identifying which color region the signal lamp 32 exists in may be performed using the same learned model. Alternatively, as another example, it may be possible to prepare in advance template data indicating arrangement of the signal lamps 32 in the traffic signal 3, and to use comparison with the prepared template data, so as to identify which color region the signal lamp 32 visible in the captured image exists in.

The color determination unit 115 performs color determination on the color region identified by the signal lamp region identification unit 114. In other words, the processing unit 11 performs color determination on the color region identified by the signal lamp region identification unit 114. Note that the signal lamp 32 lights in a predetermined color, and in a non-lighting state it has a color different from the predetermined color. For instance, in the non-lighting state, the signal lamp 32 has an inconspicuous color such as black. The color determination may be a process of determining whether or not each region has a predetermined color by lighting, for example. For instance, if a region in which the signal lamp 32 exists is identified to be the red color region, the color determination of this region may be determination whether or not it is the red color. Note that the color determination may be a process of determining which color each region has.

The color determination performed on each region may use the learned model after machine learning, for example. The machine learning may be configured for example to prepare a training data set with correct label for colors of the signal lamps, and to use the training data set for allowing the deep neural network to learn. Alternatively, as another example, it may be possible to determine a luminance value of each pixel in each region by using known image processing technique, and to perform the color determination of each region on the basis of distribution of the determined luminance values.

In this embodiment, the color determination unit 115 determines the signal color of the traffic signal 3 on the basis of the result of the color determination of each region. Note that the above-mentioned signal color of the traffic signal 3 means the color of the lighted signal lamp 32 among the plurality of signal lamps 32. Detail of a method of determining the signal color of the traffic signal 3 on the basis of the result of the color determination will be described later. Note that instead of performing color determination on each region, it may be possible to determine whether or not the signal lamp 32 lights in each region, and to determine the signal color on the basis of the result of the light determination.

<3. Signal Color Determination Method>

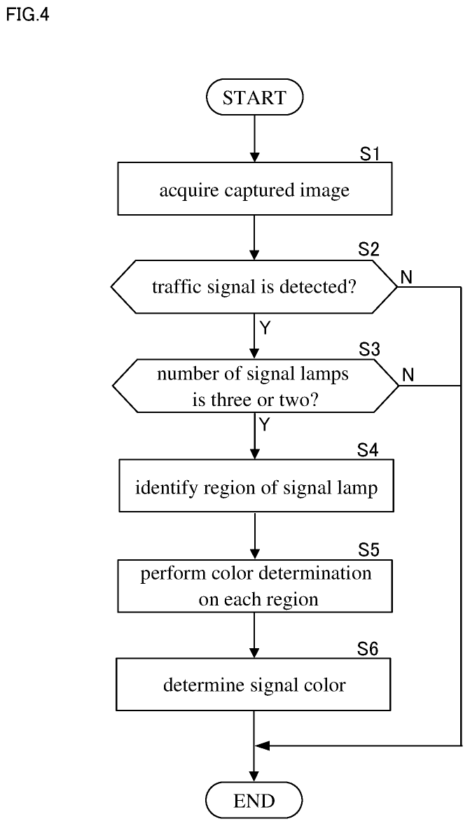

Next, a signal color determination method using the signal color determination device 1 of this embodiment is described. FIG. 4 is a flowchart illustrating an example of a flow of the signal color determination method using the signal color determination device 1 of the embodiment of the present invention. For instance, the signal color determination method may be configured to start when an engine starts if the vehicle is an engine vehicle, or to start when a power switch of the vehicle is turned on if the vehicle is an electric vehicle.

Note that the computer program that allows the computer device to realize the signal color determination method of this embodiment is included in the scope of this embodiment. In addition, a computer readable nonvolatile recording medium that stores such the computer program is included in the scope of this embodiment.

In Step S1, the image acquisition unit 111 acquires the captured image from the camera 2. In other words, the signal color determination method includes the step of acquiring the captured image. The image acquisition unit 111 acquires the captured image periodically, for example. When the captured image is acquired, the process flow proceeds to next Step S2.

In Step S2, the traffic signal detection unit 112 detects the traffic signal 3 from the acquired captured image. In other words, the signal color determination method includes the step of detecting the traffic signal from the acquired captured image. In Step S2, it is further determined whether or not the traffic signal 3 is detected. If the traffic signal 3 is detected from the captured image (Yes in Step S2), the process flow proceeds to next Step S3. If the traffic signal 3 is not detected from the captured image (No in Step S2), the process of determining the signal color of the traffic signal 3 performed on the captured image acquired in Step S1 is finished.

In Step S3, the signal lamp number estimation unit 113 estimates the number of the signal lamps 32 visible in the captured image of the detected traffic signal 3. In other words, the signal color determination method includes the step of estimating the number of the signal lamps 32 visible in the captured image of the detected traffic signal 3. Note that in this embodiment, the estimated number of the signal lamps 32 is three, two, or one. It may be possible to adopt a configuration in which the estimated number of the signal lamps 32 can be estimated to be zero.

In Step S3, it is further determined whether or not the estimated number of the signal lamps 32 is three or two. If the estimated number of the signal lamps 32 is three or two (Yes in Step S3), the process flow proceeds to next Step S4. If the estimated number of the signal lamps 32 is one (No in Step S3), the signal color determination process is finished. In other words, in this embodiment, if the estimated number of the signal lamps 32 is one, the signal color determination is not performed.

In Step S4, the signal lamp region identification unit 114 identifies which color region the signal lamp 32 visible in the captured image exists in. In other words, the signal color determination method includes the step of identifying which color region the signal lamp 32 visible in the captured image exists in. If the number of the signal lamps 32 visible in the captured image is three, it is identified that the signal lamp 32 exists in each of the three color regions (in all the color regions), and the three color regions are extracted. If the number of the signal lamps 32 visible in the captured image is two, two color regions are identified, and the two color regions are extracted. For instance, if the red color signal lamp 32a and the yellow color signal lamp 32b are visible in the captured image, the red color region and the yellow color region of the traffic signal 3 are extracted. After the color region in which the signal lamp 32 exists is extracted, the process flow proceeds to next Step S5.

In Step S5, the color determination unit 115 performs color determination on each color region identified by the signal lamp region identification unit 114. In other words, the signal color determination method includes the step of performing color determination on each identified color region. If the three color regions are identified, the color determination is performed on each of the three regions. If the two color regions are identified, the color determination is performed on each of the two regions. For instance, if the red color region and the yellow color region are identified, the color determination is performed on each of the red color region and the yellow color region. After the color determination is finished, the process flow proceeds to next Step S6.

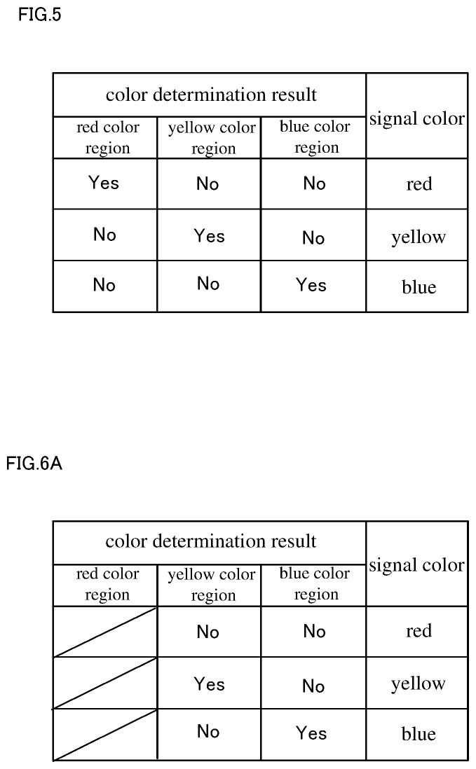

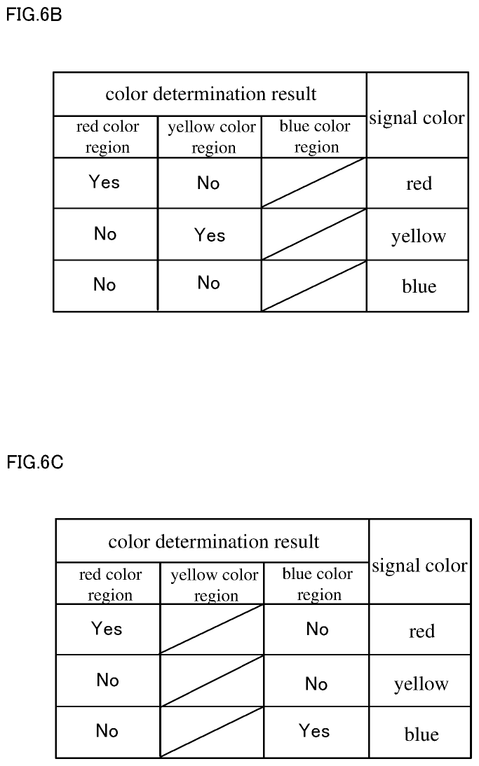

In Step S6, the signal color of the traffic signal 3 is determined on the basis of the result of the color determination of each color region. In other words, the signal color determination method includes the step of determining signal color of the traffic signal 3 on the basis of the result of the color determination in each color region. After the signal color determination of the traffic signal 3, the signal color determination method illustrated in FIG. 4 is finished. With reference to FIGS. 5, 6A, 6B, and 6C, the case where the traffic signal 3 includes the red color signal lamp 32a, the yellow color signal lamp 32b, and the blue color signal lamp 32c is exemplified for describing the signal color determination method.

FIG. 5 is a table illustrating results of color determination performed on the red color region, the yellow color region, and the blue color region, and the signal colors determined on the basis of the results. Note that FIG. 5 corresponds to the table illustrating the signal color determination method in the case where all the three signal lamps 32a, 32b and 32c are visible in the captured image. In FIG. 5, “Yes” means it is determined that the result of the color determination agrees with the color of the corresponding color region. “No” means it is determined that the result of the color determination does not agree with the color of the corresponding color region. Note that this point is the same for FIGS. 6A, 6B, and 6C referred to later.

As illustrated in FIG. 5, as the result of the color determination, if the red color region is determined to be red color, and the yellow color region is determined to be not yellow color, and the blue color region is determined to be not blue color, then the signal color is determined to be red color. In addition, as the result of the color determination, if the red color region is determined to be not red color, and the yellow color region is determined to be yellow color, and the blue color region is determined to be not blue color, then the signal color is determined to be yellow color. In addition, a the result of the color determination, if the red color region is determined to be not red color, the yellow color region is determined to be not yellow color, and the blue color region is determined to be blue color, then the signal color is determined to be blue color. In other words, if all the three signal lamps 32a, 32b and 32c are visible in the captured image, the signal color is the color of the color region in which the assumed color of the color region agrees with the color obtained by the color determination.

FIG. 6A is a table illustrating results of the color determination performed on the yellow color region and the blue color region, and signal colors determined on the basis of the results. Note that FIG. 6A corresponds to the table illustrating the signal color determination method in the case where the red color signal lamp 32a is not visible in the captured image because of an obstacle, while the yellow color signal lamp 32b and the blue color signal lamp 32c are visible in the captured image.

As illustrated in FIG. 6A, if there is not the result of the color determination of the red color region, and after the color determination if the yellow color region is determined to be not yellow color, and the blue color region is determined to be not blue color, then the signal color is determined to be red color. In addition, if there is not the result of the color determination of the red color region, and after the color determination if the yellow color region is determined to be yellow color, and the blue color region is determined to be not blue color, then the signal color is determined to be yellow color. In addition, if there is not the result of the color pndetermination of the red color region, and after the color determination if the yellow color region is determined to be not yellow color, and the blue color region is determined to be blue color, then the signal color is determined to be blue color.

FIG. 6B is a table illustrating results of the color determination performed on the red color region and the yellow color region, and signal colors determined on the basis of the results. Note that FIG. 6B corresponds to the table illustrating the signal color determination method in the case where the blue color signal lamp 32c is not visible in the captured image because of an obstacle, while the red color signal lamp 32a and the yellow color signal lamp 32b are visible in the captured image.

As illustrated in FIG. 6B, if there is not the result of the color determination of the blue color region, and after the color determination if the red color region is determined to be red color, and the yellow color region is determined to be not yellow color, then the signal color is determined to be red color. In addition, if there is not the result of the color determination of the blue color region, and after the color determination if the red color region is determined to be not red color, and the yellow color region is determined to be yellow color, then the signal color is determined to be yellow color. In addition, if there is not the result of the color determination of the blue color region, and after the color determination if the red color region is determined to be not red color, and the yellow color region is determined to be not yellow color, the signal color is determined to be blue color.

FIG. 6C is a table illustrating results of the color determination performed on the red color region and the blue color region, and signal colors determined on the basis of the results. Note that FIG. 6C corresponds to the table illustrating the signal color determination method in the case where the yellow color signal lamp 32b is not visible in the captured image because of an obstacle, while the red color signal lamp 32a and the blue color signal lamp 32c are visible in the captured image.

As illustrated in FIG. 6C, if there is not the result of the color determination of the yellow color region, and after the color determination if the red color region is determined to be red color, and the blue color region is determined to be not blue color, then the signal color is determined to be red color. In addition, if there is not the result of the color determination of the yellow color region, and after the color determination if the red color region is determined to be not red color, and the blue color region is determined to be not blue color, then the signal color is determined to be yellow color. In addition, if there is not the result of the color determination of the yellow color region, and after the color determination if the red color region is determined to be not red color, and the blue color region is determined to be blue color, then the signal color is determined to be blue color.

In other words, if only two signal lamps 32 among three signal lamps 32 are visible in the captured image, and if there is the color region in which the assumed color of the color region agrees with the color obtained by the color determination among the color regions after the color determination, then the agreed color of the color region is determined to be the signal color. If there is not the color region in which the assumed color of the color region agrees with the color obtained by the color determination among the color regions after the color determination, the color of the color region on which the color determination was not performed is determined to be the signal color.

<4. Summary of Embodiment>

As described above, when a part of the plurality of signal lamps 32 of the traffic signal 3 is detected from the captured image, the processing unit 11 determines the signal color of the traffic signal 3. In other words, the signal color determination method of this embodiment includes the step of determining the signal color of the traffic signal 3 if a part of the plurality of signal lamps 32 of the traffic signal 3 is detected from the captured image.

With this configuration, in the traffic signal 3 visible in the captured image, even if all the signal lamps 32 are not visible, the signal color of the traffic signal 3 can be determined. Therefore, it is possible to increase possibility that the signal color determination result of the traffic signal 3 can be obtained from the captured image. In addition, with this configuration, it is possible to increase the possibility that the signal color determination result can be obtained without changing a travel schedule of the vehicle. In addition, with this configuration, it is possible to increase possibility that the signal color can be obtained in such a case where the signal color of the traffic signal should be obtained from the captured image for an accident inspection or the like after the vehicle traveled.

Note that in this embodiment, the part of the plurality of signal lamps 32 are two signal lamps among three signal lamps. If the two signal lamps 32 among three signal lamps 32 are visible, the signal color of the traffic signal 3 can be determined, and hence it is possible to increase possibility that the determination result of the signal color of the traffic signal 3 can be obtained from the captured image.

In addition, in this embodiment, if all the plurality of signal lamps 32 are detected, the processing unit 11 determines the signal color of the traffic signal 3. In other words, in this embodiment, the processing unit 11 determines the signal color of the traffic signal 3 if the number of the signal lamps 32 is estimated to be three or two. With this configuration, as for the traffic signal 3 visible in the captured image, the signal color determination is performed not only in the case where all the signal lamps 32 are visible but also in the case where a part of the signal lamps 32 is visible. Therefore, possibility that the signal color determination result of the traffic signal 3 can be obtained from the captured image can be further increased.

In addition, in this embodiment, the signal color determination of the traffic signal 3 includes the process of identifying which color region the signal lamp 32 visible in the captured image exists in. This configuration is a configuration utilizing that an arrangement of colors in the traffic signal 3 is ruled, and can be applied to cases where not all the signal lamps 32 of the traffic signal 3 are visible. In other words, with this configuration, the signal color determination result can be obtained even if only two signal lamps 32 among three signal lamps 32 are visible in the captured image.

In addition, in this embodiment, the process of determining the signal color of the traffic signal 3 includes the process of performing color determination on the identified color region. With this configuration, it is possible to appropriately estimate a lighting color region by using image data.

<5. Variations>

As described above, in the configuration of determining the signal color of the traffic signal 3 if a part of the plurality of signal lamps 32 of the traffic signal 3 is detected, the part of the plurality of signal lamps 32 are two signal lamps 32 among three signal lamps 32. However, the part of the plurality of signal lamps 32 may include one signal lamp 32 among three signal lamps 32. Even in such the configuration, if the signal lamp 32 visible in the captured image is lighted, the signal color of the traffic signal 3 can be determined. Therefore, also in this configuration, possibility that the signal color determination result of the traffic signal 3 can be obtained from the captured image can be increased.

Note that if only one signal lamp 32 among the three signal lamps 32 is detected, the signal color of the traffic signal 3 may not be determined. In this case, the fact of being unable to determine may be notified. In addition, in this case, it may be possible to issue an instruction to move the vehicle to a place where two or more signal lamps 32 of the traffic signal 3 are visible, for example.

<6. Points to Be Considered>

Various technical features disclosed in the embodiment for implementing the invention described in this specification can be variously modified within the scope of this technical invention without deviating from the spirit thereof. In addition, the plurality of embodiments and variations for implementing the invention described in this specification can be combined to the extent possible.

What is claimed is:

1. A signal color determination device comprising a processor configured to acquire a captured image, wherein if a part of a plurality of signal lamps of a traffic signal is detected from the captured image, the processor determines a signal color of the traffic signal.

2. The signal color determination device according to claim 1, wherein the part of the plurality of signal lamps are two signal lamps among three signal lamps.

3. The signal color determination device according to claim 1, wherein the part of the plurality of signal lamps includes one signal lamp among three signal lamps.

4. The signal color determination device according to claim 1, wherein the processor determines the signal color of the traffic signal if all the plurality of signal lamps are detected.

5. The signal color determination device according to claim 1, wherein the process of determining the signal color of the traffic signal includes a process of identifying which color region the signal lamp visible in the captured image exists in.

6. The signal color determination device according to claim 5, wherein the process of determining the signal color of the traffic signal includes a process of performing color determination on the identified color region.

7. A signal color determination device comprising a processor configured to acquire a captured image, wherein the processor detects a three-lamp traffic signal having three signal lamps lighting in different colors from the captured image, estimates the number of the signal lamps viewed in the captured image of the detected traffic signal, and determines a signal color of the traffic signal if the number of the signal lamps is estimated to be three or two.

8. The signal color determination device according to claim 7, wherein the process of determining the signal color of the traffic signal includes a process of identifying which color region the signal lamp visible in the captured image exists in.

9. The signal color determination device according to claim 8, wherein the process of determining the signal color of the traffic signal includes a process of performing color determination on the identified color region.

10. A signal color determination method comprising the steps of:
acquiring a captured image; and
determining a signal color of a traffic signal if a part of a plurality of signal lamps of the traffic signal is detected from the captured image.
